(19) United States
(12) Patent Application Publication
(10) Pub. No.: US 2017/0345305 A1
(43) Pub. Date: Nov. 30, 2017

(54) METHOD AND APPARATUS FOR INTERNET BASED SMART PARKING SPACE OPTIMIZATION

(71) Applicant: Qiufeng Zheng, Princeton, NJ (US)

(72) Inventor: Qiufeng Zheng, Princeton, NJ (US)

(21) Appl. No.: 15/602,454

(22) Filed: May 23, 2017

Related U.S. Application Data
(60) Provisional application No. 62/342,300, filed on May 27, 2016.

(51) Int. Cl. G08G 1/14; G07C 9/00

(52) U.S. Cl. CPC G08G 1/149; G07C 9/00007; G08G 1/144

(57) ABSTRACT

The present principles allow the owners of parking spaces in a barrier gate controlled parking garage to temporarily make the parking spaces available to other users during the periods that the parking spaces are not used by the owners. The parking space owners may publish and made known the availability information of the parking spaces using their associated mobile computing devices through the internet. In addition, a universal barrier gate interfacing device and/or a universal access card are provided which would allow controlling of the operation of different kinds of barrier gate systems via a verification of a universal access code representing the agreed to parking transaction and/or parking space seeker.

### CROSS-REFERENCE TO RELATED APPLICATIONS

This application claims priority to provisional application 62/342,300, filed on May 27, 2016, which is herein incorporated by reference.

### TECHNICAL FIELD

The present principles generally relate to internet based communication and computing apparatuses, methods, and computer program products, and more particularly, to apparatuses, methods, and computer program products for internet based smart parking space optimization.

### BACKGROUND

Existing parking garages today may be categorized into three different categories. The first category comprises publicly available parking garage management systems which usually operate on a first-come first-served basis. That is, the publicly available parking garages do not know before hand, the individuals entering the parking garage nor the parking start time or end time until after an automobile has entered and/or exited the publicly available garage. The public available parking garage management system usually charges the parking customers on a predetermined price, typically depending on the duration of the parking time. The second category comprises garages with parking spaces which are owned, leased or otherwise controlled on a long term basis by private individuals or entities. These parking garages are usually associated with residential or commercial buildings and are dedicated to serving the residents and/or tenants of the associated buildings. The third category of parking garages are the hybrid garage systems which may comprise a combination of the above two categories of parking spaces. That is, the third category of garages may have some publicly available parking spaces for the general public and also dedicated spaces which are assigned to private individuals or entities.

In addition, access to the existing parking garages are typically controlled by a barrier gate control system. Many different types of barrier gate control systems are available on the market today (see, e.g., www.liftmaster.com/for-businesses/Gate-Operators/Parking-Traffic-Solution, and www.doorking.com/parking-control). These gates may have automated access control for their barrier gate systems using different types of entry devices such as e.g., access cards or key fobs. The access cards or key fobs may comprise e.g., an embedded radio frequency identification (RFID) tag, a magnetic strip, or a Weigand protocol compatible card, with access code and/or other pertinent information programmed thereon for gaining access to the garage. In an alternative, some garages provide a keypad at the barrier gate for an individual to punch in an access code in order to control the barrier gate of the garage. On the other hand, access to some of the existing barrier gated garages may just be manually controlled by a person sitting in a booth at the entrance of the garage.

### SUMMARY

The present inventor recognizes that it is advantageous to provide systems methods, and computer program products to allow e.g., an owner or of a parking space in a barrier gated parking garage management system to be able to better utilize and monetize his or her parking space when the space is not being used. As used herein, an “owner” of a parking space is broadly defined as an individual and/or an entity who and/or which is/are authorized to make a parking space available for parking by another individual and/or entity. This may happen when, for example, an owner of a residential parking space is at work so that his or her residential parking space is empty and the parking space is made available for parking from 9 AM to 5 PM, or he or she may have an office parking space which may be made available for parking in the evening or overnight.

The present inventor also recognizes that in order to be able to make his or her space available to a previously unknown, potential parking space user, an exemplary system, method or computer program product needs to provide an easy and universal way of gaining access to different types of parking garages since the existing parking garage barrier control systems are made by different companies and are typically incompatible with each other. That is, the methods and/or devices needed to gain access to the different gated garages are different for the different garages where the parking spaces may be made available for the short term lease.

According to the present principles, an exemplary apparatus is presented comprising: a communication interface configured to receive a user input from an owner of a parking space who is making the parking space available for parking wherein the user input comprising a location of the parking space and an available time period of the parking space; wherein the communication interface is further configured to receive a user request from a person seeking an available parking space; a processor configured to match the user request from the person seeking an available parking space to the parking space made available based on the user input from the owner; and the processor is further configured to provide after the match via the communication interface, a universal access code configured to enable an operation of a barrier gate of a parking garage where the parking space made available is located.

In another exemplary embodiment, a method is presented, comprising: receiving, via a communication interface, a user input from an owner of a parking space who is making the parking space available for parking wherein the user input comprising a location of the parking space and an available time period of the parking space; receiving, via the communication interface, a user request from a person seeking an available parking space; matching, via a processor, the user request from the person seeking an available parking space to the parking space made available based on the user input from the owner; and providing after the matching, via the processor and communication interface, a universal access code configured to enable an operation of a barrier gate of a parking garage where the parking space made available is located.

In another exemplary embodiment, a computer program product stored in a non-transitory computer-readable storage medium is presented, comprising computer-executable instructions for: receiving, via a communication interface, a user input from an owner of a parking space who is making the parking space available for parking wherein the user input comprising a location of the parking space and an available time period of the parking space; receiving, via the communication interface, a user request from a person seeking an available parking space; matching, via a processor, the user request from the person seeking an available parking space to the parking space made available based on the user input from the owner; and providing after the matching, via the processor and communication interface, a universal access code configured to enable an operation of a barrier gate of a parking garage where the parking space made available is located.

### BRIEF DESCRIPTION OF THE DRAWINGS

FIG. 1 illustrates an exemplary apparatus according to the present principles;

FIG. 2 also illustrates an exemplary apparatus according to the present principles;

FIG. 3 illustrates an exemplary process according to the present principles;

FIG. 4 also illustrates an exemplary process according to the present principles; and

FIG. 5 illustrates another exemplary apparatus according to the present principles.

The examples set out herein illustrate exemplary embodiments of the present principles. Such examples are not to be construed as limiting the scope of the invention in any manner.

### DETAILED DESCRIPTION

The present principles allow the owners of e.g., privately owned or controlled parking spaces (hereinafter private parking spaces) to turn their barrier gate controlled or open, non-gated private parking spaces into temporarily paid parking spaces available to other users during the periods that the private parking spaces are unoccupied. The parking space owners may publish and made known, using their associated mobile computing devices through the internet, the parking space availability information to a Smart Parking Garage Control System (SPGCS) server according to the present principles.

Accordingly, the SPGCS server may calculate a relative market demand based pricing for the posted available parking space according to the relative number of available parking spaces in the geographical area and the number of parking space seekers in the area at a given time. Parking space seekers will be able to temporarily lease a parking space through auctions or market demand pricing deals via an exemplary method and system according to the present principles.

According to another exemplary aspect of the present principles, once the parking seeker has agreed to the terms and conditions for the parking space, for garages with a barrier gate, SPGCS creates a universal gate access control code and sends the code to e.g., a parking garage barrier control system where the parking space is located and/or the parking space seeker. The barrier gate of the associated garage will grant access to the parking space user when the correct code is presented at the barrier gate by the parking space seeker.

In one exemplary embodiment, this universal gate access control code may be displayed as, e.g., a bar code, a QR code, an alphanumeric, or a numeric code on a display of a mobile computing device associated with the parking space seeker. In another non-limiting exemplary embodiment, the universal gate access control code may be converted to near field communication (NFC) data and to be transmitted as an NFC RF signal. Therefore, this universal gate access control code sent to the mobile computing device of the parking space seeker may be read and processed by exemplary universal access code reader of an exemplary universal barrier gate interfacing device. In another exemplary embodiment, the universal access code uniquely represents a corresponding registered parking garage seeker of the present exemplary system according to the present principles, and the universal access code is presented in different formats in an exemplary universal access card. Therefore, the exemplary universal access card may be used to gain entry/exit in different types of barrier gated garages.

According the another aspect of the present principles, the universal access code received by the parking space seeker from the SPGCS server is to be presented and processed by an exemplary universal gate access control interfacing device according to another exemplary aspect of the present principles. The exemplary universal gate access control interfacing device will also receive this universal gate access control code independently from the exemplary SPGCS sever and when the access code input by the parking space seeker matches the access code sent independently from the SPGCS to the universal gate access control interfacing device, the exemplary universal gate access control interfacing device will send a signal to open the particular barrier gate control system where the parking space is located.

According to another exemplary aspect of the present principles, open parking spaces located in non-barrier gated area, such as at a single privately-owned house, a townhouse, or an apartment, the exemplary SPGCS will use the parking space user's reported in and out times, car GPS location tracking and/or parking space owner's video camera etc. to identify the parking duration.

In another exemplary aspect of the present principles, the SPGCS will automatically charge the parking space user's corresponding account and/or credit/debit card based on the calculated parking time. The parking fee/revenue will be shared automatically through the present internet based computing system with e.g., the private parking space owner, the parking garage management company, and/or other associated entities, based on an algorithm or algorithms utilized by the present internet based computing and communication system and method.

Other than the inventive concept, elements shown in the figures which are well known in the art will not be described in detail herein. For example, familiarity with existing technologies such as computing and mobile devices, computer servers, cloud computing, storage devices, and proximity cards, communication technologies such as cellular and wireless communications (e.g., 4G, LTE, and WiFi), global positioning systems (GPS), and other internet communications are well known and not described in detail herein. Also, computing and communication technologies such as bar code, QR code, alphanumeric, numeric code, and/or NFC data generation or processing are also well known and not described in detail herein. Furthermore, barrier gate control system for a parking garage is also well known and not described in detailed.

The present description illustrates the present principles. It will thus be appreciated that those skilled in the art will be able to devise various arrangements that, although not explicitly described or shown herein, embody the present principles and are included within its spirit and scope. All examples and conditional language recited herein are intended for pedagogical purposes to aid the reader in understanding the present principles and the concepts contributed by the inventors to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure. Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment”, “an embodiment”, “an exemplary embodiment” of the present principles, or as well as other variations thereof, means that a particular feature, structure, characteristic, and so forth described in connection with the embodiment is included in at least one embodiment of the present principles. Thus, the appearances of the phrase “in one embodiment”, “in an embodiment”, “in an exemplary embodiment”, or as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The present principles provide for the private parking space owners an account in an exemplary computing system to register their available parking spaces into SPGCS and provide an available time period (e.g., information such as location, parking space number, direction to the parking space, date(s) and time(s), and etc.) to SPGCS though a PC, a smart phone or a tablet, and etc. via the internet. SPGCS will calculate the available parking spaces in the area and the number of customers who want to park in the area at a given time. SPGCS will generate a fixed price for the potential parking space seeker to agree to, and/or an auction minimum price for the potential customers to start the bidding on. In one exemplary embodiment, the auction may be for a short period of time, such as 1 to 60 minutes, or has a “buy it now” price so that the deal may be consummated quickly and the parking seeker can have a space to park shortly.

After the deal has been agreed to, SPGCS will indicate in its database that the parking space has been reserved to the parking space user who has agreed to the price and the terms of the temporary parking space. In one exemplary embodiment, if a term of the agreement is to have the parking space prepaid by the parking space user, the agreed to amount will be automatically deducted from the account of the parking space user by SPGCS.

According to another exemplary aspect of the present principles, if the garage where the agreed to parking space is in an open parking garage without a barrier gate, SPGCS sends confirmation information including the direction to the parking space and the price and the terms of the agreement to the parking space user and parking space owner respectively.

According to another exemplary aspect of the present principles, if the garage is a barrier gate controlled parking garage, SPGCS generates a universal barrier gate access code representing the agreed to parking transaction and/or parking space seeker and sends it to the parking space user's mobile device, and in an exemplary embodiment, also to a universal barrier gate interfacing device. The universal barrier gate interfacing device is configured to allow the input of the access code and is able to verify whether an access code received from a parking space user is a valid access code by communicating with SPGCS through the internet. Once this code is verified, the universal barrier gate interfacing device will generate an open gate command based on the manufacturer and the model of the particular barrier gate. Accordingly, by using this innovative universal barrier gate interfacing device, any garages which are participating in the present parking sharing computing and communications system according to the present principles may be entered into using a universal access code generated dynamically by SPGCS to be associated with a particular available parking space, the agreed to parking transaction, and/or a particular parking space user.

In another exemplary aspect of the present principles, the exemplary universal access code may only be valid within a certain time period. That is, the universal access code may be valid within, e.g., 5 minutes of the agreed to start time of the parking transaction and will expire 5 minutes before the expiration of the agree-to parking transaction. This would allow better parking space management so that no two cars for the same parking space are in the same garage at the same time.

In another exemplary aspect of the present principles, SPGCS may also provide and/or make recommendations on other value-added services related to automobiles such as, e.g., car washing, waxing, detailing, repair, etc. as an alternative to parking. That is, the present exemplary system may make recommendations or provide electronic advertisements that instead of spending the time parking, the parking space seeker may drive to one of the automobile related services nearby and leave his or her car there for servicing instead.

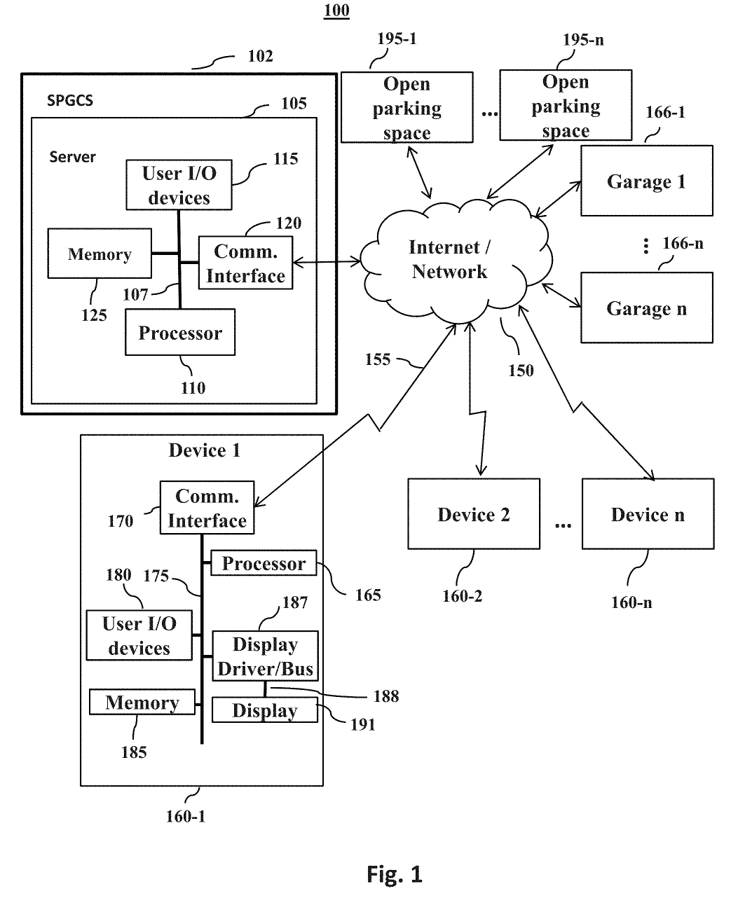

FIG. 1 shows an exemplary system 100 according to the present principles. The exemplary system 100 in FIG. 1 comprises a Smart Parking Garage Control System (SPGCS) server 105 located at a SPGCS location 102 according to the present principles. SPGCS server 105 is capable of receiving and processing user requests from one or more of user devices 160-1 to 160-n. The server 105, in response to the user requests, provides the relevant data and content to the user devices 160-1 to 160-n.

Various exemplary user devices 160-1 to 160-n in FIG. 1 may communicate with the SPGCS server 105 over a communication network 150 such as, e.g., the internet, a wide area network (WAN), and/or a local area network (LAN). SPGCS server 105 may communicate with user devices 160-1 to 160-n in order receive e.g., relevant information from an owner of an available parking space such as, e.g., owner account registration information including owner address, billing, credit card, bank account, PayPal account information, available parking space location, and/or time period information (e.g., information such as location, parking space number, direction to the parking space, available date(s) and time(s), and etc.).

Likewise, a potential parking space seeker may also use one of the exemplary user devices 160-1 to 160-n in FIG. 1 to create an account on the SPGCS server 105 including his or her name, address, billing information and etc. The parking space seeker may also input their desired parking space requirement including the time and preferred location of the parking space being sought. SPGCS server 105 will process the request and match the requirement with the available parking spaces in the area and generate, e.g., a list of the available parking spaces and corresponding prices to be sent to one of an associated exemplary user devices 160-1 to 160-n of the potential parking space seeker to be agreed to, and/or an auction minimum price for the potential customers to start the bidding on. In addition, server 105 may also provide additional processing of information and data when the processing is not available and/or not capable of being conducted on the local user devices 160-1 to 160-n.

SPGCS server 105 shown in FIG. 1 may represent and be implemented as a dedicated server or as part of a cloud computing platform, and/or the SPGCS may be implemented in a centralized or distributed environment. Also, the SPGCS server may be implemented as a single server or a cluster of servers. As an example, SPGCS server 105 may be a computer having (or a cluster of computers each having) a processor 110 such as, e.g., an Intel processor, running an appropriate operating system such as, e.g., Windows 2008 R2, Windows Server 2012 R2, Linux operating system, and etc.

User devices 160-1 to 160-n shown in FIG. 1 may be one or more of, e.g., a PC, a laptop, a tablet, or a cellphone. Examples of such devices may be, e.g., a Microsoft Windows 10 computer/tablet, an Android phone/tablet, an Apple 105 phone/tablet, a digital television receiver, or the like. A detailed block diagram of an exemplary user device according to the present principles is illustrated in block 160-1 of FIG. 1 as Device 1 and will be further described below.

An exemplary user device 160-1 in FIG. 1 comprises a processor 165 for processing various data and for controlling various functions and components of the device 160-1. The processor 165 communicates with and controls the various functions and components of the device 160-1 via a control bus 175 as shown in FIG. 1. For example, the processor 165 provides processing of various web data and content to be displayed on the user devices 160-1 to 160-n.

Device 160-1 may also comprise a display 191 which is driven by a display driver/bus component 187 under the control of processor 165 via a display bus 188 as shown in FIG. 1. The display 191 may be a touch display in accordance with the present principles. In addition, the type of the display 191 may be, e.g., LCD (Liquid Crystal Display), LED (Light Emitting Diode), OLED (Organic Light Emitting Diode), and etc. In addition, an exemplary user device 160-1 according to the present principles may have its display outside of the user device, or that an additional or a different external display may be used to display the content provided by the display driver/bus component 187 (not shown).

In additional, exemplary device 160-1 in FIG. 1 may also comprise various user input/output (I/O) devices 180. The user interface devices 180 of the exemplary device 160-1 may represent e.g., a mouse, touch screen capabilities of a display (e.g., display 191), a touch and/or a physical keyboard. The user interface devices 180 of the exemplary device 160-1 may also comprise a speaker or speakers, and/or other indicator devices, for outputting visual and/or audio sound, user data and feedback.

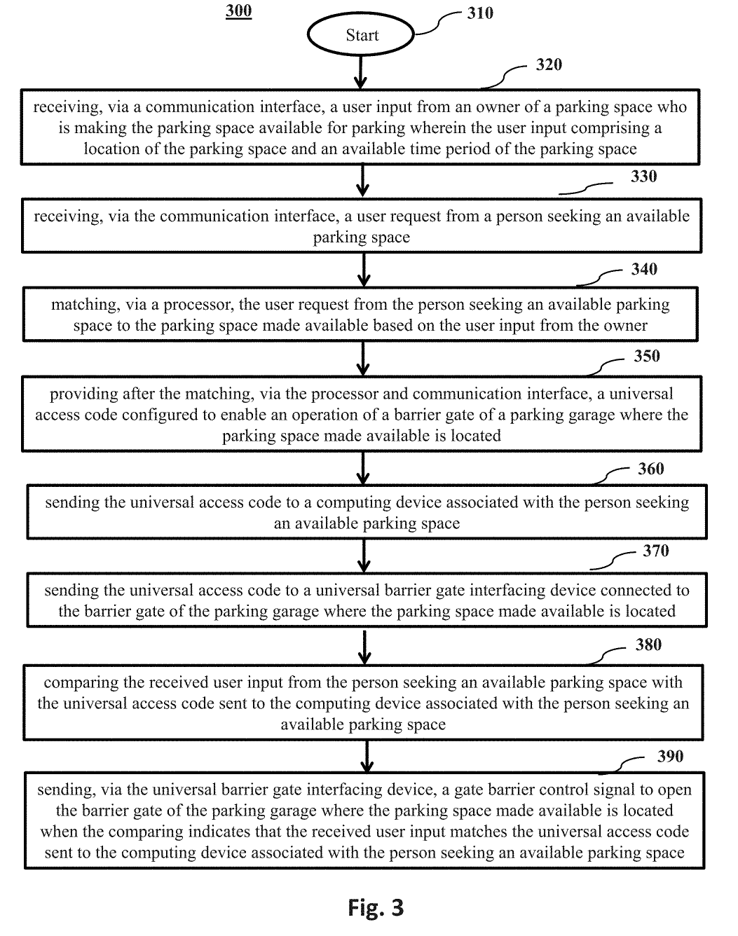

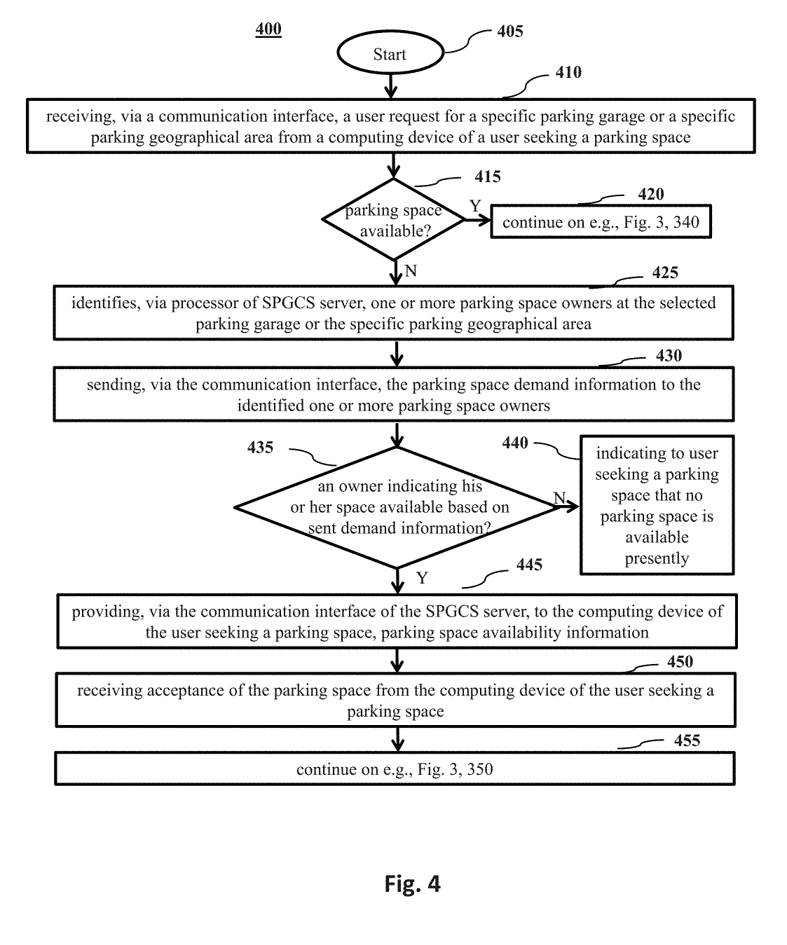

Exemplary device 160-1 also comprises a memory 185 which may represent both a transitory memory such as RAM, and a non-transitory memory such as a ROM, a hard drive, a CD drive, a Blu-ray drive, and/or a flash memory, for processing and storing different files and information as necessary, including computer program products and software (e.g., as represented by a flow chart diagram of FIG. 3 or FIG. 4, as to be discussed below), webpages, user interface information, various databases, and etc., as needed. In addition, device 160-1 also comprises a communication interface 170 for connecting and communicating to/from server 105 and/or other devices, via, e.g., the network 150 using a link 155 representing, e.g., a connection through a cable network, a FIOS network, a Wi-Fi network, and/or a cellphone network (e.g., 3G, 4G, LTE, 5G), and etc.

According to the present principles, user devices 160-1 to 160-n in FIG. 1 may access, if applicable, different computing programs, user interface screens, web pages, services or databases provided by server 105 using, e.g., HTTP protocol. A well-known web server software application which may be run by server 105 to provide web pages is Apache HTTP Server software available from http://www.apache.org.

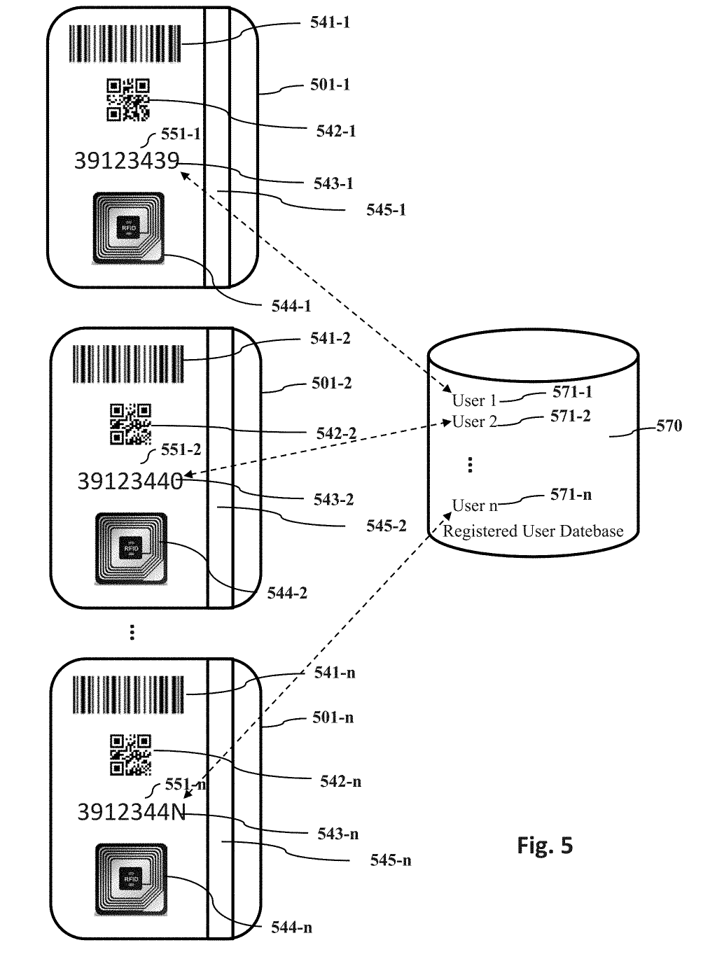

Turning to further detail of SPGCS server 105 of FIG. 1, the server 105 may comprise a processor 110 which controls the various functions and components of the server 105 via a control bus 107 as shown in FIG. 1. In addition, a server administrator may interact with and configure server 105 to run different applications using different user input/output (I/O) devices 115 (e.g., a keyboard and/or a display) as well known in the art. Server 105 also comprises a memory 125 which may represent both a transitory memory such as RAM, and a non-transitory memory such as a ROM, a hard drive, a CD drive, a Blu-ray drive, and/or a flash memory, for processing and storing different files and information as necessary, including computer program products and software (e.g., as represented by a flow chart diagram of FIG. 3 or FIG. 4, as to be discussed below), webpages, user interface information, user account information, databases (such as e.g., database 570 shown in FIG. 5 as to be discussed below), search engine software, algorithm(s) for computing revenue sharing and etc., as needed. Databases may be stored in the non-transitory memory 125 of sever 105 as necessary, so that e.g., various user account information, parking availability information, and/or pricing information may be stored and computed.

In addition, server 105 is connected to network 150 through a communication interface 120 for communicating with other servers or web sites (not shown) and one or more user devices 160-1 to 160-n, as shown in FIG. 1. In addition, one skilled in the art would readily appreciate that other well-known server components, such as, e.g., power supplies, cooling fans, etc., may also be needed, but are not shown in FIG. 1 to simplify the drawing.

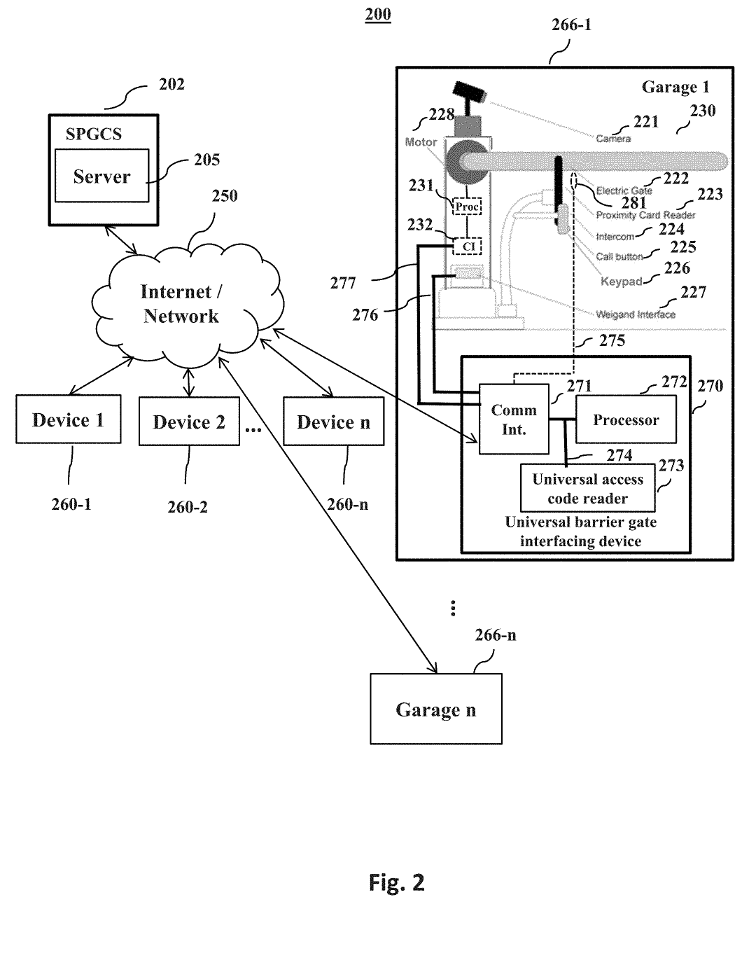

According to the present principles, SPGCS server 105 of FIG. 1 is also connected to various exemplary garages 166-1 to 166-n. These garages may represent one or more garages which may have a barrier gate control system at the entrance of the corresponding garage. The detail of these garages according to an exemplary aspect of the present principle will be described below in connection with FIG. 2. In addition, SPGCS server 105 of FIG. 1 may also communicate with one or more open parking spaces 195-1 to 195-n which may not be located in a barrier gate controlled garages. For example, SPGCS server 105 of FIG. 1 may communicate with a WiFi or cellular communications capable camera and/or other vehicle monitoring device (e.g., a laser detector) located at one or more of the open spaces 195-1 to 195-n to monitor and/or verify the parking activities at those spaces.

FIG. 2 shows another exemplary apparatus 200 according to the present principles. In particular, FIG. 2 illustrates an exemplary universal barrier gate interfacing device 270 according to the present principles. As shown in FIG. 2, a garage 1 266-1 comprises a barrier gate 230. Barrier gate 230 has an electronic camera 221, an electric gate 222, a proximity card (e.g., RFID card) reader 223, an intercom 224, a call button 225 and a keypad 226 for entering an access code, and a Weigand interface 227, and an electric motor 228 for operating the electric gate 222. Since these elements of the barrier gate 230 are well-known in the art, they will not be described in detail herein.

According to the present principles and as shown in FIG. 2, a universal barrier gate interfacing device 270 is provided in order to be able to interface with different types and models of barrier gate devices manufactured by different manufacturers, having different types of gate opening and closing operations, and/or requiring different user devices. The exemplary universal barrier gate interfacing device 270 is also provided so that the SPGCS server 205 is able to communicate to the existing garage location 266-1. Accordingly, the exemplary universal barrier gate interfacing device 270 is able to be used to universally open and/or close the different kinds of barrier gates as to be described in further detail below, via a universal access code sent from the SPGCS 202 in an exemplary aspect of the present principles.

The exemplary universal barrier gate interfacing device 270 comprises a processor 272, a communication interface 271, and a universal access code reader 273. These elements of the interfacing device 270 are interconnected by a control bus 274 so that the communication interface 271 and the universal access code reader 273 are controllable by the processor 272. In addition, the communication interface 271 may be used to communicate with the SPGCS server 205 through the internet/network 250 as shown in FIG. 2. Furthermore, the exemplary universal barrier gate interfacing device 270 may also communicate with the exemplary barrier gate 230 in one or more exemplary ways as shown in FIG. 2 as to be described further below. The communication interface 271 shown in FIG. 2 may represent one or more different physical communication interface modules and/or the one or more physical communication interface modules may be capable of providing communications in one or more protocols, depending on the design, need and the capability of a particular barrier gate being interfaced.

In one exemplary embodiment, the exemplary universal barrier gate interfacing device 270 may communicate with and control the operation of the exemplary barrier gate 230 via a Weigand interface 227 of the barrier gate 230 using e.g., a compatible cable 276 as shown in FIG. 2. The Weigand interface is a de facto wiring standard which arose from the popularity of Weigand effect card readers in the 1980s. It is commonly used to connect a card swipe mechanism to the rest of an electronic entry system. A Weigand-compatible reader is normally connected to a Weigand-compatible security panel. The Weigand interface uses three wires, one of which is a common ground and two of which are data transmission wires usually called DATA0 and DATA1, alternately labeled “D0” and “D1” or “Data Low” and “Data High”. When no data is being sent, both DATA0 and DATA1 are pulled up to the “high” voltage level—usually +5 VDC. When a 0 is sent the DATA0 wire is pulled to a low voltage while the DATA1 wire stays at a high voltage. When a 1 is sent the DATA1 wire is pulled to a low voltage while DATA0 stays at a high voltage. The communications protocol used on a Weigand interface is known as the Weigand protocol and is well known in the art.

In another embodiment according to the present principles, the exemplary universal barrier gate interfacing device 270 may communicate with an existing barrier control system via a proprietary or another industry standard internal processor communication/control bus interface 232 as shown in FIG. 2 in order to communication with and/or control the internal processor 231 of the barrier gate 230. This is illustrated by using another applicable compatible cable/data path 277 as shown in FIG. 2.

According the present principles, the exemplary universal barrier gate interfacing device 270 also comprises a universal access code reader 273 in order to read and process the access code residing in a mobile computing device of the person who has consummated the parking space transaction. As already described above, the universal access code has been sent from the SPGCS server 205 to the associated mobile device of a parking space seeker once the terms of the parking arrangement has been agreed to and the payment has been successfully processed. Also as already described above, this universal gate access control code may be displayed as, e.g., a bar code, a QR code, an alphanumeric, or a numeric code on a display of a mobile computing device associated with the parking space seeker. In another non-limiting exemplary embodiment, the universal gate access control code may be converted to a near field communication (NFC) data and to be transmitted as an NFC RF signal as well known in the art.

Accordingly, an exemplary universal access code reader 273 may represent e.g., a bar code, a QR code, an alphanumeric, a numeric code reader, and/or a proximity card format (e.g., RFID or NFC) reader so that the universal access code may be successfully read and processed. In another exemplary embodiment according to the present principles, the exemplary universal access code reader 273 may represent just a keyboard so that the universal gate access control code sent to the parking space seeker may be entered manually by the parking space seeker. In another exemplary embodiment, this code may also be entered into by the parking space seeker or the parking garage attendant using the existing keypad 226 of the existing barrier gate 230 as shown in FIG. 2. In another exemplary embodiment, the keyboard entry of the universal access code may be used as a backup when the automated code reading by universal access code reader has failed.

In another non-limiting exemplary aspect of the present principles, an exemplary universal access code is provided which uniquely identifies a particular parking space seeker in the SPGCS. This code would allow the present principles to provide an easy-to-use universal access card for each user of the present exemplary system to be used to open the different types of barrier gated garages. This exemplary aspect is illustrated in FIG. 5.

As shown in FIG. 5, one exemplary aspect of the present principles is a universal access card 501-1 to 501-n, each having a respective universal access code 551-1 to 551-n. Each of the respective access code 551-1 to 551-n uniquely identifies a corresponding registered parking space user 571-1 to 571-n of the SPGCS (e.g., residing in an exemplary database 570 of the SPGCS server 105 of FIG. 1 or 205 of FIG. 2). In another exemplary aspect of the present principles, each universal access card 501-1 to 501-n may comprise different formats/representations of the unique universal access code. For example, as shown in FIG. 5, card 501-1 may comprises different formats/representations of an exemplary universal access code value of 39123439 550-1. On the same access card 501-1, this code 551-1 is represented in a bar code format 541-1, QR code format, 542-1, Numeric/Alphanumeric format 543-1, RFID data format 544-1 (e.g., proximity card format), and magnetic strip data format 545-1.

Accordingly, the universal access card 501-1 to 501-n shown in FIG. 5 may be used to gain access to the different existing garages having the different types of entry/exit access methods and user entry/exit access devices. For example, this card may be used to open the barrier access gate 230 via the existing proximity card reader 223 as shown in FIG. 2, since each universal access card 501-1 to 501-n has a respective RFID chip embedded as shown in FIG. 5. In addition, this access card may also be read by the exemplary universal access code reader 273 shown in FIG. 2 as already described above.

In another exemplary embodiment according to the present principles, once this code has been read and processed, it is compared in order to verify that this is indeed the code which was sent from the SPGCS server 205 for this particular parking transaction and/or parking space seeker. In one exemplary embodiment, this comparison is made in the exemplary universal barrier gate interfacing device 270 by having the SPGCS server 205 also send the universal access code for this parking transaction and/or parking space user independently to the interfacing device 270. In another embodiment, the comparison is made at the SPGCS server 205 by sending the code input by the parking space seeker over the internet to the SPGCS server 205. Once the access code input by the parking space seeker has been verified as the correct universal access code, processor 272 of the universal barrier gate interfacing device 270 may send a control signal via one of the communication interfaces as described above with the applicable protocol to instruct processor 231 of the barrier gate 230 to perform the open operation of the gate 231. Therefore, the parking patron may drive into the garage 1 266-1 and park his or her car.

In another non-limiting example, if the barrier gate garage where the agreed to parking space is located is manually operated by a garage attendant, the parking space user may just show the access code to the garage attendant for him or her to open the barrier gate manually.

In another exemplary embodiment according to the present principles, the exemplary universal barrier gate interfacing device 270 may also comprise an external proximity card emulator 281 which would emulate e.g., an NFC RF data transmission in order to control the operation of the existing barrier gate 230. Accordingly, the exemplary external proximity card emulator 281 may transmit an appropriate open gate signal to open the barrier gate 230 when the universal barrier gate interface device determines that the universal access code input by the parking space seeker is correct via the comparison as described above.

FIG. 3 shows an exemplary process 300 according to the present principles. The exemplary process 300 starts at 310. At 320, the process receives, via a communication interface, a user input from an owner of a parking space who is making the parking space available for parking wherein the user input comprising a location of the parking space and an available time period of the parking space. At 330, the process receives, via the communication interface, a user request from a person seeking an available parking space. At 340, the process matches, via a processor, the user request from the person seeking an available parking space to the parking space made available based on the user input from the owner. At 350, the process provides after the matching, via the processor and communication interface, a universal access code configured to enable an operation of a barrier gate of a parking garage where the parking space made available is located. At 360, the process sends the universal access code to a computing device associated with the person seeking an available parking space. At 370, the process sends the universal access code to a universal barrier gate interfacing device connected to the barrier gate of the parking garage where the parking space made available is located. At 380, the process compares the received user input from the person seeking an available parking space with the universal access code sent to the computing device associated with the person seeking an available parking space. At 390, the process sends, via the universal barrier gate interfacing device, a gate barrier control signal to open the barrier gate of the parking garage where the parking space made available is located when the comparing indicates that the received user input matches the universal access code sent to the computing device associated with the person seeking an available parking space.

FIG. 4 shows another exemplary process 400 according to the present principles. This exemplary process 400 when implemented by the present exemplary computer and communication system 100 and/or 200 shown in FIG. 1 and/or FIG. 2 would allow owners of parking spaces in garages and/or in a geographical area which are in demand by potential parking space seekers to adjust their own parking behavior in order to make their parking spaces available to meet the demand.

Accordingly, the exemplary process 400 starts at 405 as shown in FIG. 4. At 410, the process receives, via e.g., a communication interface 120 of the SPGCS server 105 in FIG. 1, a user request for a specific parking garage or a specific parking geographical area from a computing device of a user seeking a parking space. At 415, a determination is made by e.g., processor 110 of SPGCS server 105 in FIG. 1 whether there is parking space available in the specific parking garage or the specific parking geographical area. At 420, if the determination is yes, then the process continues on e.g., at 340 of FIG. 3 as already described previously. If on the other hand, the determination is no, then at 425, the process identifies, via processor 110 of SPGCS server, one or more parking space owners at the selected parking garage or the specific parking geographical area. At 430, the process sends via the communication interface, the parking space demand information to the identified one or more parking space owners.

Continuing on at 435 of FIG. 4, a determination is made by the processor of SPGCS server whether one of the one or more identified parking space owners has indicated his or her space is available based on the sent demand information. At 440, if the determination is no, then an indication is sent to the user seeking a parking space that no parking space is available presently. On the other hand at 445, if the determination is yes, then SPGCS server provides, via the communication interface of the SPGCS server, to the computing device of the user seeking a parking space, parking space availability information. At 450, an acceptance of the parking space from the computing device of the user seeking a parking space is received from the parking space seeker if he or she agrees to the terms of the parking transaction. At 455, the process continues at, e.g., 350 of FIG. 3 as already described previously.

Accordingly, the present principles provide a solution to the problem that the barrier gate garage management system only accept one, pre-registered, single garage gate opening device and pre-selected code by presenting an inventive universal access code via an inventive universal barrier gate interfacing device 270 and/or a universal access card 501-1. Therefore, the present principles allow private parking garages to become temporary public parking garages and to allow better utilization of the available, unused parking spaces.

In view of the above, the foregoing merely illustrates the present principles applying to apparatuses, methods, and computer instructions stored in a non-transitory computer medium. It will thus be appreciated that those skilled in the art will be able to devise numerous alternative arrangements which, although not explicitly described herein, embody the present principles and are within its spirit and scope. It is also therefore to be understood that numerous modifications may be made to the illustrative embodiments and that other arrangements may be devised without departing from the spirit and scope of the present principles as defined by the appended claims.

1. An apparatus comprising:
a communication interface configured to receive a user input from an owner of a parking space who is making the parking space available for parking wherein the user input comprising a location of the parking space and an available time period of the parking space; wherein the communication interface is further configured to receive a user request from a person seeking an available parking space; and
a processor configured to match the user request from the person seeking an available parking space to the parking space made available based on the user input from the owner; and
the processor is further configured to provide after the match via the communication interface, a universal access code configured to enable an operation of a barrier gate of a parking garage where the parking space made available is located.

2. The apparatus of claim 1 wherein the processor is further configured to send via the communication interface the universal access code to a computing device associated with the person seeking an available parking space.

3. The apparatus of claim 2 wherein the processor is further configured to send via the communication interface the universal access code to a universal barrier gate interfacing device connected to the barrier gate of the parking garage where the parking space made available is located.

4. The apparatus of claim 3 wherein the processor is further configured to receive, via the communication interface, from the computing device associated with the person seeking an available parking space, a signal indicating an acceptance of the matching before the sending of the universal access code to the computing device associated with the person seeking an available parking space.

5. The apparatus of claim 3 wherein the universal barrier gate interfacing device is configured to receive a user input from the person seeking an available parking space.

6. The apparatus of claim 5 wherein the universal barrier gate interfacing device is further configured to compare the received user input from the person seeking an available parking space with the universal access code sent to the computing device associated with the person seeking an available parking space.

7. The apparatus of claim 6 wherein the universal barrier gate interfacing device is further configured to send a gate barrier control signal to open the barrier gate of the parking garage where the parking space made available is located when the comparing indicates that the received user input matches the universal access code sent to the computing device associated with the person seeking an available parking space.

8. The apparatus of claim 2 wherein a universal barrier gate interfacing device connected to the barrier gate of the parking garage where the parking space is located is configured to receive a user input from the person seeking an available parking space;
and the universal barrier gate interfacing device is further configured to send the received user input to the processor.

9. The apparatus of claim 8 wherein the processor is further configured to compare the received user input from the person seeking an available parking space with the universal access code sent to the computing device associated with the person seeking an available parking space.

10. The apparatus of claim 9 wherein the processor is further configured to send to the universal barrier gate interfacing device a gate barrier control signal to open the barrier gate of the parking garage where the parking space made available is located when the comparing indicates that the received user input matches the universal access code sent to the computing device associated with the person seeking an available parking space.

11. A method comprising:
receiving, via a communication interface, a user input from an owner of a parking space who is making the parking space available for parking wherein the user input comprising a location of the parking space and an available time period of the parking space;
receiving, via the communication interface, a user request from a person seeking an available parking space;
matching, via a processor, the user request from the person seeking an available parking space to the parking space made available based on the user input from the owner; and
providing after the matching, via the processor and communication interface, a universal access code configured to enable an operation of a barrier gate of a parking garage where the parking space made available is located.

12. The method of claim 11 further comprising sending the universal access code to a computing device associated with the person seeking an available parking space.

13. The method of claim 12 further comprising sending the universal access code to a universal barrier gate interfacing device connected to the barrier gate of the parking garage where the parking space made available is located.

14. The method of claim 13 further comprising receiving, via the communication interface, from the computing device associated with the person seeking an available parking space, a signal indicating an acceptance of the matching before the sending of the universal access code to the computing device associated with the person seeking an available parking space.

15. The method of claim 13 further comprising receiving, via the universal barrier gate interfacing device, a user input from the person seeking an available parking space.

16. A computer program product stored in a non-transitory computer-readable storage medium, comprising computer-executable instructions for:
receiving, via a communication interface, a user input from an owner of a parking space who is making the parking space available for parking wherein the user input comprising a location of the parking space and an available time period of the parking space;
receiving, via the communication interface, a user request from a person seeking an available parking space;
matching, via a processor, the user request from the person seeking an available parking space to the parking space made available based on the user input from the owner; and
providing after the matching, via the processor and communication interface, a universal access code configured to enable an operation of a barrier gate of a parking garage where the parking space made available is located.

17. The apparatus of claim 1 wherein the processor is further configured to send via the communication interface the universal access code to a universal barrier gate interfacing device connected to the barrier gate of the parking garage where the parking space made available is located.

18. The apparatus of claim 17 wherein the universal access code uniquely identifies the person seeking an available parking space.

19. The apparatus of claim 18 wherein the universal access code is presented in different formats on a universal access card.

20. The method of claim 11 further comprising sending the universal access code to a universal barrier gate interfacing device connected to the barrier gate of the parking garage where the parking space made available is located.
